(19) United States
(12) Patent Application Publication
(10) Pub. No.: US 2006/0185100 A1
(43) Pub. Date: Aug. 24, 2006

(54) Fibre-reactive azo dyes, their preparation and their use

(76) Inventor: Athanassios Tzikas, Pratteln (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/549,524

(22) PCT Filed: Mar. 17, 2004
(86) PCT No.: PCT/EP04/50314

§ 371 Date: Sep. 19, 2005

(30) Foreign Application Priority Data
Mar. 27, 2003 (EP) 03405210.0

(51) Int. Cl. C09B 62/00

(52) U.S. Cl. 8/543

(57) ABSTRACT

Reactive dyes of formula (1) wherein R₁, R₂, R₃ and R₄ are each independently of the others hydrogen or unsubstituted or substituted C₁-C₄alkyl, (R₅)ₛ denotes s identical or different substituents selected from the group halogen, sulfo, carboxy, C₁-C₄alkyl and C₁-C₄alkoxy, B is an aliphatic bridging member, X₁ and X₂ are halogen, r is an integer from 0 to 2, s is an integer from 0 to 3, and n and m are each independently of the other a number 1 or 2, and Z is a fibre-reactive group of formula —SO₂—Y (2a), —NH—CO—(CH₂)_{K}—SO₂—Y (2b), —CONH—(CH₂)I—SO₂—Y (2c), —NH—CO—CH(Hal)-CH₂-Hal (2d) or —NH—CO—C(Hal)=CH₂ (2e) wherein Hal is chlorine or bromine, k and I are each independently of the other a number 2, 3 or 4, and Y is vinyl or a radical —CH₂—CH₂—U and U is a group removable under alkaline conditions are suitable for dyeing cellulosic or amide-group-containing fibre materials.

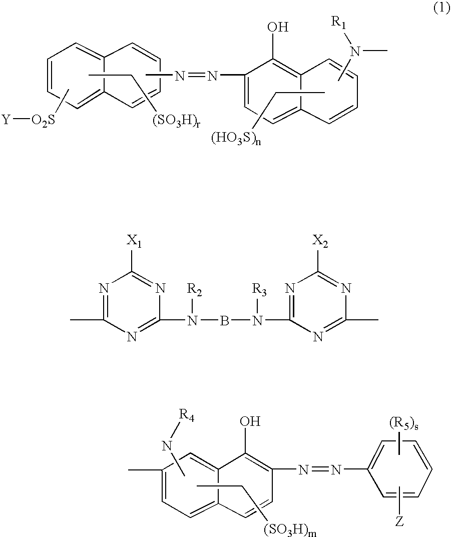

The present invention relates to novel reactive dyes, to processes for the preparation thereof and to the use thereof in dyeing or printing textile fibre materials.

The practice of dyeing using reactive dyes has recently led to higher demands being made of the quality of the dyeings and the profitability of the dyeing process. As a result, there is still a need for novel reactive dyes having improved properties, especially in respect of their application.

Dyeing nowadays requires reactive dyes that have sufficient substantivity and at the same time have good ease of washing off of unfixed dye. They should also have a good tinctorial yield and high reactivity, the objective being to provide especially dyeings having high degrees of fixing. The known dyes do not satisfy these requirements in all properties.

The dyes known from U.S. Pat. No. 4,323,497 are symmetrical in terms of the diazo components used and still have certain disadvantages in respect of the above-mentioned properties.

The problem underlying the present invention is therefore to find, for the dyeing and printing of fibre materials, novel improved reactive dyes that possess the qualities described above to a high degree. The novel dyes should especially be distinguished by high fixing yields and high fibre-dye bond stability. The dyes should also yield dyeings having good all-round fastness properties, for example light-fastness and wet-fastness properties.

It has been shown that the problem posed is largely solved by the novel dyes defined below.

The present invention accordingly relates to reactive dyes of formula 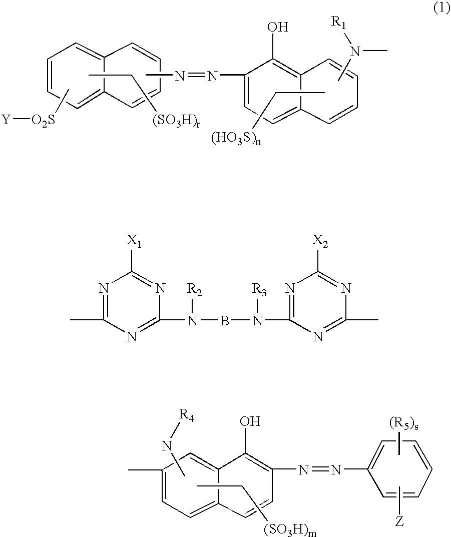
wherein
R₁, R₂, R₃ and R₄ are each independently of the others hydrogen or unsubstituted or substituted C₁-C₄alkyl,
(R₅)ₛ denotes a identical or different substituents selected from the group halogen, sulfo, carboxy, C₁-C₄alkyl and C₁-C₄alkoxy,
B is an aliphatic bridging member,
X₁ and X₂ are halogen,
r is an integer from 0 to 2,
s is an integer from 0 to 3, and
n and m are each independently of the other a number 1 or 2, and
Z is a fibre-reactive group of formula
—SO₂—Y (2a),
—NH—CO—(CH₂)ₖSO₂—Y (2b),
—CONH—(CH₂)_{I}SO₂—Y (2c),
—NH—CO—CH(Hal)CH₂-Hal (2d) or
—NH—CO—C(Hal)=CH₂ (2e)
wherein
Hal is chlorine or bromine,
k and I are each independently of the other a number 2, 3 or 4, and
Y is vinyl or a radical —CH₂—CH₂—U and U is a group removable under alkaline conditions.

The dyes of formula (1) contain at least two, preferably from 2 to 6 and especially 4 or 5, sulfo groups, which are each present either in free acid form or, preferably, in salt form. Suitable salts are, for example, alkali metal, alkaline earth metal or ammonium salts, salts of an organic amine, or mixtures thereof. Examples that may be mentioned are sodium, lithium, potassium or ammonium salts, a mono-, di- or tri-ethanolamine salt or mixed Na/Li or Na/Li/NH₄ salts.

The radicals R₁, R₂, R₃ and R₄ in the reactive dye of formula (1) which are alkyl radicals are straight-chained or branched. The alkyl radicals may be further substituted, for example by hydroxy, sulfo, sulfato, cyano or carboxy. As examples the following radicals may be mentioned: methyl, ethyl, n-propyl, isopropyl, n-butyl, sec-butyl, tert-butyl or isobutyl, and also the corresponding radicals substituted by hydroxy, sulfo, sulfato, cyano or carboxy. Preferred substituents am hydroxy, sulfo or sulfato, especially hydroxy or sulfato and more especially hydroxy.

R₁ and R₄ preferably are each independently of the other hydrogen or C₁-C₄alkyl, especially hydrogen.

R₂ and R₃ preferably are each independently of the other hydrogen or C₁-C₄alkyl which is unsubstituted or substituted by hydroxy, sulfo, sulfate, cyano or carboxy. In an interesting embodiment, one of the radicals R₂ and R₃ is C₁-C₄alkyl which is substituted by hydroxy, sulfo, sulfate, cyano or carboxy and the other of the radicals R₂ and R₃ is hydrogen or C₁-C₄alkyl, especially hydrogen.

R₂ and R₃ especially are each independently of the other hydrogen or C₁-C₄alkyl, more especially hydrogen.

In an important embodiment of the present invention, R₁, R₂, R₃ and R₄ are each independently of the others hydrogen or C₁-C₄alkyl, especially hydrogen.

As C₁-C₄alkyl for R₅ there come into consideration each independently of any other(s), for example, methyl, ethyl, n-propyl, isopropyl, n-butyl, sec-butyl, tert-butyl or isobutyl, preferably methyl or ethyl, and especially methyl.

As C₁-C₄alkoxy for R₅ there come into consideration each independently of any other(s), for example, methoxy, ethoxy, n-propoxy, isopropoxy, butoxy or isobutoxy, preferably methoxy or ethoxy, and especially methoxy.

As halogen for Re there come into consideration each independently of any other(s), for example, fluorine, chlorine or bromine, preferably chlorine or bromine, and especially chlorine.

B is, for example, straight-chain or branched C₂-C₁₂alkylene which is unsubstituted or substituted by hydroxy, C₁-C₄alkoxy, sulfato or sulfo and which may be interrupted once or more than once by —O— or —NR₈—; preferably —O—, R₈ being hydrogen or C₁-C₄alkyl, preferably hydrogen, methyl or ethyl and especially hydrogen. B preferably is straight-chain or branched C₂-C₈alkylene which is unsubstituted or substituted by hydroxy, sulfo or sulfato, especially hydroxy, and more especially is straight-chain or branched C₂-C₆alkylene. Examples of preferred radicals B are 1,2-ethylene, 1,2-propylene, 1,3-propylene, 2-hydroxy-1,3-propylene, 1,4-butylene, 2,2-dimethyl-1,3-propylene, 2-methyl-1,5-pentylene, 1,6-hexylene.

Of special interest as bridging members B are those C₂-C₆alkylene radicals which correspond to the formula —CH₂—CH(R₇)— or —R₇)CH—CH₂— wherein R₇ is C₁-C₄alkyl, especially methyl. Of very special importance for B is the meaning 1,2-propylene.

X₁ and X₂ preferably are each independently of the other chlorine or fluorine, and especially chlorine. The radicals X₁ and X₂ are identical or not identical; the radicals X₁ and X₂ preferably are identical and denote chlorine.

r is preferably a number 1 or 2, especially 1.

s is preferably a number 0, 1 or 2, especially 0 or 1.

n and m are preferably, in each case, the number 2.

Z is preferably a radical of formula (2a), (2b) or (2c), especially formula (2a), wherein k, I and Y have the definitions and preferred meanings given above.

As a group U removable under alkaline conditions there come into consideration, for example, —Cl, —Br, —F, —OSO₃H, —SSO₃H, —OCO—CH₃, —OPO₃H₂, —OCO—C₆H₅, —OSO₂—C₁-C₄alkyl and —OSO₂—N(C₁-C₄alkyl)₂. U is preferably a group of formula —Cl, —OSO₃H, —SSO₃H, —OCO—CH₃, —OCO—C₆H₅ or —OPO₃H₂, especially —Cl or —OSO₃H and more especially —OSO₃H.

Examples of suitable radicals Y are accordingly vinyl, β-bromo- or β-chloro-ethyl, β-acetoxy-ethyl, β-benzoyloxyethyl, β-phosphatoethyl, β-sulfatoethyl and β-thiosulfatoethyl. Y is preferably vinyl, β-chloroethyl or β-sulfatoethyl and especially vinyl or β-sulfatoethyl.

Hal is preferably bromine.

k and I preferably are each independently of the other a number 2 or 3.

More especially, k is the number 3 and I is the number 2.

Preferred reactive dyes of formula (1) are the reactive dyes of formula 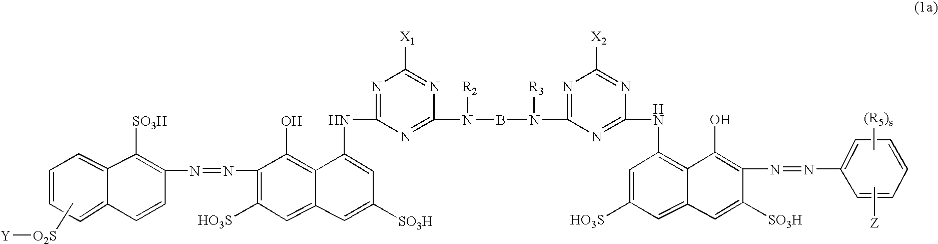
wherein
R₂, R₃, R₅, B, X₁, X₂, Y, Z and s have the respective definitions and preferred meanings given above.

Special preference is given to reactive dyes of formula (1a) wherein

R₂ and R₃ are hydrogen,

(R₅)ₛ denotes s identical or different substituents selected from the group sulfo, methyl and methoxy,

B corresponds to a radical of formula —CH₂—CH(R₇)— or —(R₇)CH—CH₂— wherein R₇ is methyl,

X₁ and X₂ are chlorine,

s is an integer from 0 to 2, preferably 0, and

Z is a fibre-reactive group of formula (2a) given above wherein Y is vinyl or β-sulfatoethyl.

The present invention relates also to a process for the preparation of compounds of formula (I), wherein approximately 1 molar equivalent of each of the compounds of formulae 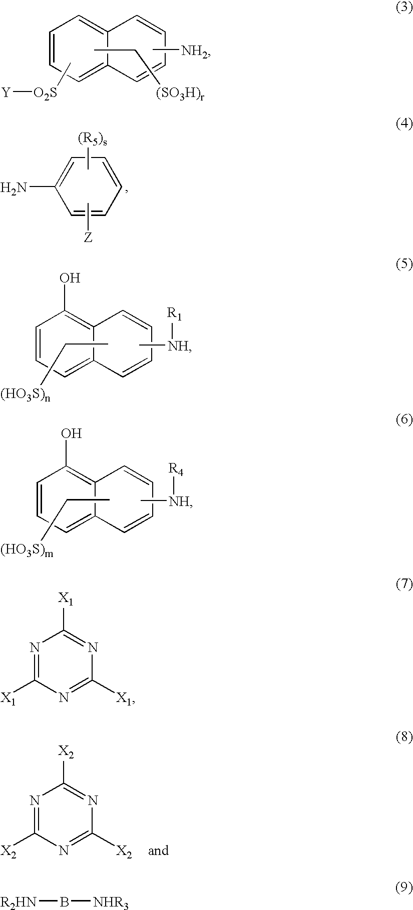
are reacted with one another in a suitable order, R₁, R₂, R₃, R₄, R₅, B, X₁, X₂, Y, Z, n, m, r and s having the respective definitions and preferred meanings given above.

As cyanuric halide of formulae (7) and (8) there are suitable cyanuric chloride and cyanuric fluoride, especially cyanuric chloride.

The compounds of formulae (7) and (8) are identical or not identical, preferably identical.

As compounds of formulae (5) and (6) there come into consideration, for example, 1-amino-8-naphthol-3,6-disulfonic acid (H acid), 1-amino-8-naphthol-4,6-disulfonic acid (K acid), 2-amino-8-naphthol-6-sulfonic acid (γ acid), 2-amino-5-naphthol-7-sulfonic acid (J acid) and also 2-methylamino-5-naphthol-7-sulfonic acid (N-methyl-J acid). Preference is given to H acid and K acid, especially H acid.

The compounds of formulae (5) and (6) are identical or not identical, preferably identical.

As compound of formula (3) there come into consideration, for example, 2-amino-6-(β-sulfatoethylsulfonyl)naphthalene, 2-amino-6-(β-sulfatoethylsulfonyl)naphthalenesulfonic acid and 2-amino-8-(β-sulfatoethylsulfonyl)naphthalene-6-sulfonic acid. 2-Amino-6-(β-sulfatoethylsulfonyl)naphthalenesulfonic acid is obtained, for example, by sulfonating and sulfating 2-amino-6-(β-hydroxyethylsulfonyl)naphthalene with sulfuric add by methods known per se.

Diazotisation of the compounds of formulae (3) and (4) and the coupling thereof, for example, to the compounds of formulae (5) and (6) or a reaction product of the compounds of formulae (5) and (7), and (6) and (8) is carried out in customary manner, for example by diazotising the compound of formula (3) and (4) in a mineral acid solution, for example a hydrochloric-acid-containing solution, with a nitrite, for example sodium nitrite, at a low temperature, for example from 0 to 5° C., and then coupling with the appropriate coupling component in a neutral to slightly acidic medium, for example at a pH from 3 to 7, preferably from 4.5 to 6.5, and at low temperatures, for example from 0 to 30° C.

The condensation reactions, for example between the compounds of formulae (5) and (7), and (6) and (8), and the reaction product of the compounds of formulae (3), (5) and (7) and (4), (6) and (8) with the diamine of formula (9) are generally carried out analogously to known methods, usually in aqueous solution at temperatures of, for example, from 0 to 50° C. and at a pH of, for example, from 3 to 10.

Because the process steps indicated above can be carried out in different orders, in some cases also simultaneously, different process variants are possible. The reaction is generally carried out step-wise, the order of the simple reactions between the individual reaction components advantageously being governed by the particular conditions. In a preferred embodiment:
(i) approximately one molar equivalent of an amine of formula (5) is condensed with approximately one molar equivalent of cyanuric halide of formula (7) and, to the resulting product of formula 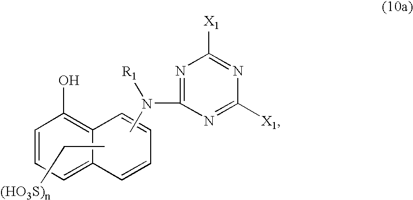
there is coupled approximately one molar equivalent of the diazotised compound of formula (3), whereupon the compound of formula 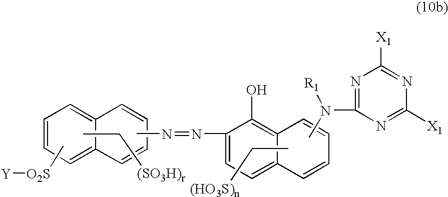
is obtained;
(ii) approximately one molar equivalent of an amine of formula (6) is condensed with approximately one molar equivalent of cyanuric halide of formula (8) and, to the resulting product of formula 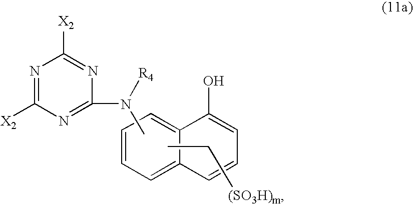
there is coupled approximately one molar equivalent of the diazotised compound of formula (4), whereupon the compound of formula 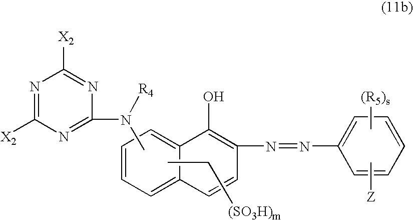
   is obtained; and
   (iii) approximately one molar equivalent of a diamine of formula (9) is condensed with approximately one molar equivalent of one of the compounds of formulae (10b) and (1 b) obtained according to (i) and (ii), whereupon the compound of formula 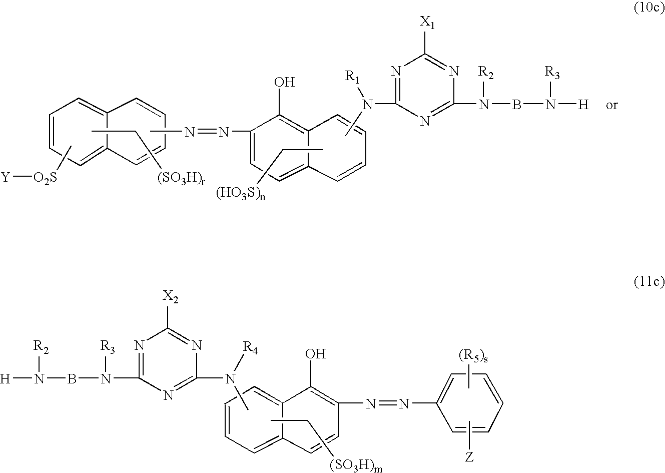
   is obtained; and
   the compound of formula (10c) or (11c) is condensed with, in each case, approximately one molar equivalent of the other compound of formula (10b) or (11 b) obtained according to (i) and (ii).

The compounds of formulae (3), (4), (5), (6), (7), (8) and (9) are known or can be prepared in analogy to known compounds.

The dyes according to the invention are fibre-reactive. Fibre-reactive compounds are to be understood as being those which are capable of reacting with the hydroxyl groups of cellulose, with the amino, carboxy, hydroxy or thiol groups in wool and silk or with the amino and possibly carboxy groups of synthetic polyamides to form covalent chemical bonds.

The dyes according to the invention are suitable for dyeing and printing an extremely wide variety of materials, such as hydroxyl-group-containing or nitrogen-containing fibre materials. Examples are silk, leather, wool, polyamide fibres and polyurethanes and also especially cellulosic fibre materials of all kinds. Such cellulosic fibre materials are, for example, the natural cellulosic fibres, such as cotton, linen and hemp, and also cellulose and regenerated cellulose. The dyes according to the invention are also suitable for dyeing or printing hydroxyl-group-containing fibres present in blend fabrics, e.g. matures of cotton with polyester fibres or polyamide fibres. The dyes according to the invention are especially suitable for dyeing or printing cellulosic, especially cotton-containing, fibre materials. They may also be used for dyeing or printing natural or synthetic polyamide fibre materials.

The dyes according to the invention can be applied to the fibre material and flied to the fibre in a variety of ways, especially in the form of aqueous dye solutions and dye print pastes. They are suitable both for the exhaust process and for dyeing in accordance with the pad-dyeing process, according to which the goods are impregnated with aqueous, optionally salt-containing, dye solutions and the dyes are fixed, after treatment with an alkali or in the presence of an alkali, optionally under the action of heat or as a result of being kept at room temperature for several hours. After fixing, the dyeings or prints are thoroughly rinsed with cold and hot water, optionally with addition of an agent that has a dispersing action and promotes diffusion of unfixed dye.

The dyes according to the invention are distinguished by high reactivity, good fixing capacity and very good build-up capacity. They can therefore be used in the exhaust dyeing process at low dyeing temperatures and require only short steaming times in the pad-steam process. The degrees of fixing are high and unfixed dye can be washed off readily, the difference between the degree of exhaust and the degree of fixing being remarkably small, that is to say the soaping loss is very small. The dyes according to the invention are also especially suitable for printing, more especially on cotton, and also for printing nitrogen-containing fibres, for example wool or silk or blend fabrics that contain wool or silk.

The dyeings and prints produced using the dyes according to the invention have a high tinctorial strength and a high fibre-dye binding stability in both the acidic and the alkaline range, as well as good fastness to light and very good wet-fastness properties, such as fastness to washing, to water, to seawater, to cross-dyeing and to perspiration, and also good fastness to pleating, to hot pressing and to rubbing.

The present invention relates also to aqueous inks comprising a reactive dye of formula (1), the respective definitions and preferred meanings given above applying for R₁, R₂, R₃, R₄, B, X₁, X₂, Y, Z, n, m, r and s.

The dyes used in the inks should preferably have a low salt content, that is to say they should have a total content of salts of less than 0.5% by weight, based on the weight of the dyes. Dyes that have relatively high salt contents as a result of their preparation and/or as a result of the subsequent addition of diluents can be desalted, for example, by membrane separation procedures, such as ultrafiltration, reverse osmosis or dialysis.

The inks preferably have a total content of dyes of from 1 to 35% by weight, especially from 1 to 30% by weight and preferably from 1 to 20% by weight, based on the total weight of the ink. As a lower limit, a limit of 1.5% by weight, preferably 2% by weight and especially 3% by weight, is preferred.

The inks may comprise water-miscible organic solvents, for example C₁-C₄alcohols, such as methanol, ethanol, n-propanol, isopropanol, n-butanol, sec-butanol, tert-butanol and isobutanol; amides, e.g. dimethylformamide and dimethylacetamide; ketones or ketone alcohols, e.g. acetone and diacetone alcohol; ethers, e.g. tetrahydrofuran and dioxane; nitrogen-containing heterocylic compounds, e.g. N-methyl-2-pyrrolidone and 1,3-dimethyl-2-imidazolidone; polyalkylene glycols, e.g. polyethylene glycol and polypropylene glycol; C₂-C₆-alkylene glycols and thioglycols, e.g. ethylene glycol, propylene glycol, butylene glycol, triethylene glycol, thiodiglycol, hexylene glycol and diethylene glycol; further polyols, e.g. glycerol and 1,2,6-hexanetriol; and C₁-C₄alkyl ethers of polyhydric alcohols, e.g. 2-methoxyethanol, 2-(2-methoxyethoxy)ethanol, 2-(2-ethoxyethoxy)ethanol, 2-[2-(2-methoxyethoxy) ethoxy]ethanol and 2-[2-(2-ethoxyethoxy)ethoxy]ethanol; preferably N-methyl-2-pyrrolidone, diethylene glycol, glycerol or especially 1,2-propylene glycol, usually in an amount of from 2 to 30% by weight, especially from 5 to 30% by weight and preferably from 10 to 25% by weight, based on the total weight of the ink.

The inks may also comprise solubilisers, e.g. ε-caprolactam.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethylcellulose, hydroxyethylcellulose, methyl hydroxyethylcellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids or poly(meth)acrylamides.

The inks comprise such thickeners, for example, in an amount of from 0.01 to 2% by weight, especially from 0.01 to 1% by weight and preferably from 0.01 to 0.5% by weight, based on the total weight of the ink.

The inks may also comprise buffer substances, e.g. borax, borates, phosphates, polyphosphates or citrates. Examples that may be mentioned include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value of, for example, from 4 to 9, especially from 5 to 8.5.

As further additives, the inks may comprise surfactants or humectants.

Suitable surfactants include commercially available anionic or non-ionic surfactants. As humectants in the inks according to the invention there come into consideration, for example, urea or a mixture of sodium lactate (advantageously in the form of a 50% to 60% aqueous solution) and glycerol and/or propylene glycol in amounts of preferably from 0.1 to 30% by weight, especially from 2 to 30% by weight.

Preference is given to inks having a viscosity of from 1 to 40 mPa·s, especially from 1 to 20 mPa·s and preferably from 1 to 10 mPa·s.

The inks may also comprise customary additives, such as antifoam agents or especially substances that inhibit the growth of fungi and/or bacteria. Such additives are usually used in amounts of from 0.01 to 1% by weight, based on the total weight of the ink.

The inks can be prepared in customary manner by mixing together the individual constituents in the desired amount of water.

The inks according to the invention are especially suitable for use in recording systems of a kind wherein an ink is expressed from a small opening in the form of droplets that are directed towards a substrate on which an image is produced. Suitable substrates are, for example, paper, textile fibre materials or plastics films. Suitable recording systems are, for example, commercially available inkjet printers for use in paper or textile printing, or writing instruments, such as fountain pens or ballpoint pens and especially inkjet printers.

Depending on the nature of its use, it may be necessary for e.g. the viscosity or other physical properties of the ink, especially those properties affecting the affinity for the substrate in question, to be modified as appropriate.

As examples of paper that can be printed with the inks according to the invention there may be mentioned commercially available inkjet paper, photo paper, glossy paper, plastics-coated paper, e.g. Epson inkjet paper, Epson photo paper, Epson glossy paper, Epson glossy film, HP special inkjet paper, Encad photo gloss paper and IIford photo paper. Plastics films that can be printed with the inks according to the invention are, for example, transparent or cloudy/opaque. Suitable plastics films are, for example, 3M transparency film.

As textile fibre materials there come into consideration, for example, nitrogen-containing or hydroxy-group-containing fibre materials, for example textile fibre materials of cellulose, silk, wool or synthetic polyamides, preferably cellulose.

The present invention accordingly relates also to a method of printing textile fibre materials, paper or plastics films, preferably textile fibre materials or paper and especially textile fibre materials, by the inkjet printing method, wherein an aqueous ink comprising a reactive dye of formula (1) is used, the respective definitions and preferred meanings given above applying for R₁, R₂, R₃, R₄, R₅, B, X₁, X₂, Y, Z, n, m, r and s.

In the inkjet printing method, individual droplets of the ink are sprayed onto a substrate in a controlled manner from a nozzle. For this purpose, predominantly the continuous inkjet method and the drop-on-demand method are used. In the continuous inkjet method, the droplets are produced continuously and any droplets not required for the printing are conveyed to a collecting vessel and recycled, whereas in the drop-on-demand method droplets are produced and printed as required; that is to say droplets are produced only when required for the printing. The production of the droplets can be effected, for example, by means of a piezo-inkjet head or by means of thermal energy (bubble jet). Preference is given to printing by means of a piezo-inkjet head for the method according to the invention. In addition, preference is given to printing in accordance with the continuous inkjet method for the method according to the invention.

The recordings, e.g. prints, which are produced are distinguished especially by a high degree of colour strength and of colour brilliance and also by good light- and wet-fastness properties.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

### EXAMPLE 1

(a) 19 parts of cyanuric chloride are mixed vigorously and thoroughly with 50 parts of ice/water and 5 parts of disodium hydrogen phosphate, with the addition of a wetting agent To the resulting suspension there is added, dropwise, a neutral solution of 32 parts of i-amino-8-hydroxynaphthalene-3,6-disulfonic acid (H acid) in such a manner that the pH of the reaction mixture does not exceed 3. Afterwards, the pH is maintained at 3 for a further 2 hours by adding sodium hydroxide solution.

(b) 28 parts of 2-(4-aminophenylsulfonyl)ethyl hydrogen sulfate (4-(β-sulfatoethylsulfonyl)-aniline) are suspended in 300 parts of water and dissolved using saturated sodium carbonate solution at pH 6 and cooled to 0° C.; 7 parts of sodium nitrite, 50 parts of ice and 30 parts of concentrated HCl are added and diazotisation is carried out for 2 hours. Afterwards, excess nitrite is destroyed using sulfamic acid.

(c) The diazo solution according to (b) is added to the reaction mixture according to (a) over about 30 minutes, the pH is raised to 4.5 over three hours using saturated sodium acetate solution and the temperature is maintained between 0 and 5° C.

(d) After the coupling is complete there is added to the resulting reaction mixture a solution, neutralised using hydrochloric acid, of 15 parts of 1,2-diaminopropane in 150 parts of water, the pH is maintained at 5 using 4N sodium hydroxide solution and the mixture is allowed to warm up to room temperature. After the reaction is complete, the reaction product, which in the form of the free acid corresponds to the formula 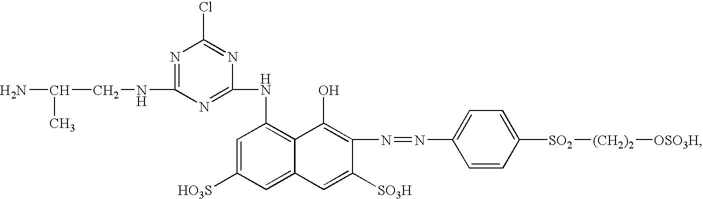
is precipitated by adding potassium chloride, filtered off, washed with saturated potassium chloride solution and dried in vacuo at 40° C.
(e) 41 parts of 2-amino-6-(β-sulfatoethylsulfonyl)naphthalenesulfonic acid are suspended in 400 parts of water; 7 parts of sodium nitrite, 50 parts of ice and 30 parts of concentrated hydrochloric acid are added and stirring is carried out for three hours. After destroying excess nitrite using sulfamic acid, the suspension is added dropwise to a further batch of the reaction mixture according to (a) and the pH is raised to 4.5 over 2 hours using solid sodium acetate, yielding, after coupling has taken place, the compound which in the form of the free acid corresponds to the formula 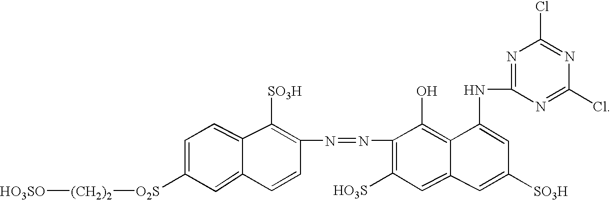
(f) 80 parts of the compound prepared according to (d) are suspended in 600 parts of warm water and added dropwise at pH 8.5 to the reaction mixture prepared according to (e). For the duration of the condensation, the pH is maintained at 8.5 using dilute sodium hydroxide solution; heating is then carried out to 30° C. and the pH is maintained at 11 for 30 minutes. After being neutralised with dilute hydrochloric acid, the reaction mixture is largely desalted by dialysis and is concentrated in vacuo. The compound which in the form of the free acid corresponds to the formula 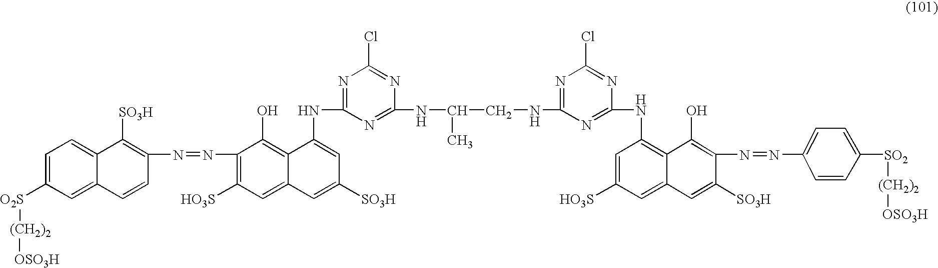
is obtained and dyes cotton a red shade with good all-round fastness properties.

### EXAMPLES 2-8

The following dyes, each of which dyes cellulose a red shade with good all-round fastness properties, can be prepared in a manner analogous to that described in Example 1. 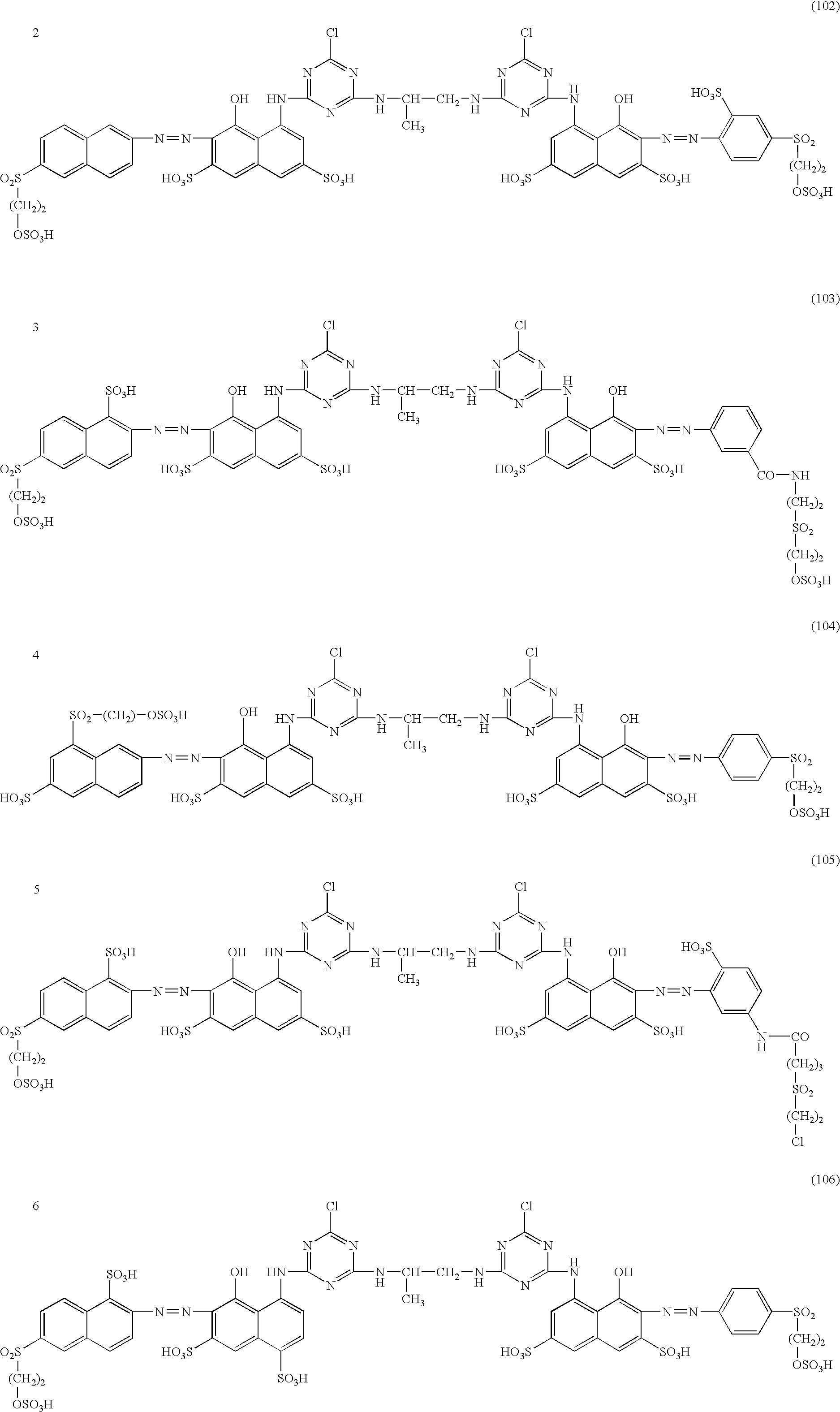 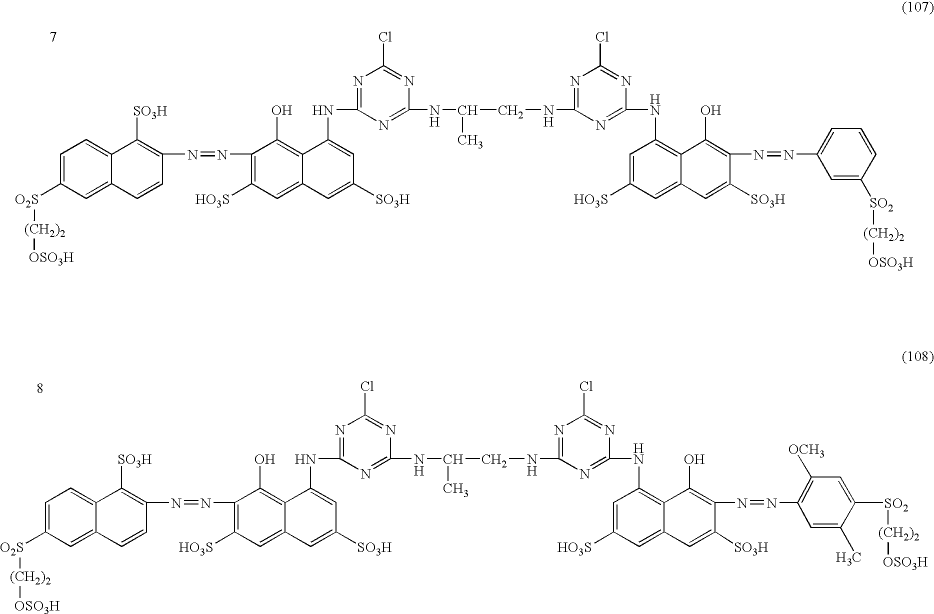
Dyeing Procedure I

100 parts of cotton fabric are placed at 60° C. in 1500 parts of a dyebath containing 45 g/l of sodium chloride and 2 parts of the reactive dye obtained according to Example 1. After 45 minutes at 60° C., 20 g/l of calcined soda are added. Dyeing is continued at that temperature for a further 45 minutes. The dyed goods are then rinsed, soaped at the boll for a quarter of an hour with a non-ionic detergent, rinsed again and dried.

As an alternative to the described procedure, dyeing can be carried out at 80° C. instead of at 60° C.

Dyeing Procedure II

0.1 part of the dye according to Example 1 is dissolved in 200 parts of water, and 0.5 part of sodium sulfate, 0.1 part of a levelling agent (based on the condensation product of a higher aliphatic amine and ethylene oxide) and 0.5 part of sodium acetate are added. The pH is then adjusted to a value of 5.5 with acetic acid (80%). The dyebath is heated at 50° C. for 10 minutes and then 10 parts of a woollen fabric are added. The dyebath is heated to a temperature of 100° C. in the course of about 50 minutes and dyeing is carried out at that temperature for 60 minutes. The dyebath is then cooled to 90° C. and the dyed goods are removed. The woollen fabric is washed with hot and cold water, then spun and dried.

Printing Procedure I

While stirring rapidly, 3 parts of the dye obtained according to Example 1 are sprinkled into 100 parts of a stock thickener containing 50 parts of 5% sodium alginate thickener, 27.8 parts of water, 20 parts of urea, 1 part of sodium m-nitrobenzenesulfonate and 1.2 parts of sodium hydrogen carbonate. The print paste so obtained is used to print a cotton fabric; drying is carried out and the resulting printed fabric is steamed in saturated steam at 102° C. for 2 minutes. The printed fabric is then rinsed, if desired soaped at the boil and again rinsed, and then dried.

Printing Procedure II

(a) Mercerised cotton-satin is padded using a liquor containing 30 g/l of sodium carbonate and 50 g, of urea (liquor uptake 70%) and dried.

(b) The cotton-satin pro-treated according to Step (a) is printed using an aqueous ink containing

15% by weight of the reactive dye of formula (101) according to Example 1

15% by weight of 1,2-propylene glycol and

70% by weight of water using a drop-on-demand inkjet head (bubble jet). The print is dried completely and fixed in saturated steam at 102° C. for 8 minutes, cold-rinsed, washed off at the boil, rinsed again and dried.

1. A reactive dye of formula 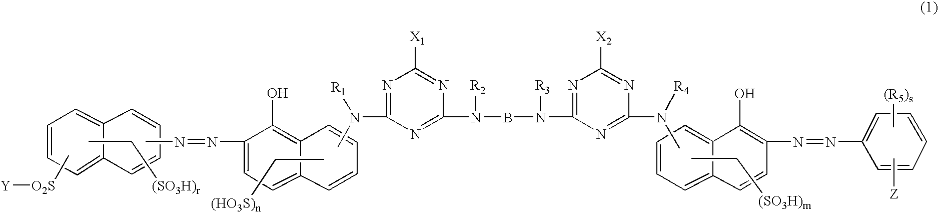
wherein
R₁, R₂, R₃ and R₄ are each independently of the others hydrogen or unsubstituted or substituted C₁-C₄alkyl,
(R₅)ₛ denotes s identical or different substituents selected from the group halogen, sulfo, carboxy, C₁-C₄alkyl and C₁-C₄alkoxy,
B is an aliphatic bridging member,
X₁ and X₂ are halogen,
r is an integer from 0 to 2,
s is an integer from 0 to 3, and
n and m are each independently of the other a number 1 or 2, and
Z is a fibre-reactive group of formula
—SO₂—Y (2a),
—NH—CO—(CH₂)ₖ—SO₂—Y (2b),
—CONH—(CH₂)_{I}—SO₂—Y (2c),
—NH—CO—CH(Hal)-CH₂-Hal (2d) or
—NH—CO—C(Hal)=CH₂ (2e)
wherein
Hal is chlorine or bromine,
k and I are each independently of the other a number 2, 3 or 4, and
Y is vinyl or a radical —CH₂—CH₂—U and U is a group removable under alkaline conditions.

2. A reactive dye according to claim 1, wherein
R₁, R₂, R₃ and R₄ are each independently of the others hydrogen or C₁-C₄alkyl.

3. A reactive dye according to claim 1, wherein
B is a radical of formula —CH₂—CH(R₇)— or —(R₇)CH—CH₂— wherein R₇ is C₁-C₄alkyl.

4. A reactive dye according to claim 1, wherein X₁ and X₂ are chlorine.

5. A reactive dye according to claim 1, wherein n and m are in each case the number 2.

6. A reactive dye according to claim 1, wherein Z is a radical of formula
—SO₂—Y (2a)
wherein
Y is vinyl or β-sulfatoethyl.

7. A reactive dye according to claim 1, corresponding to formula 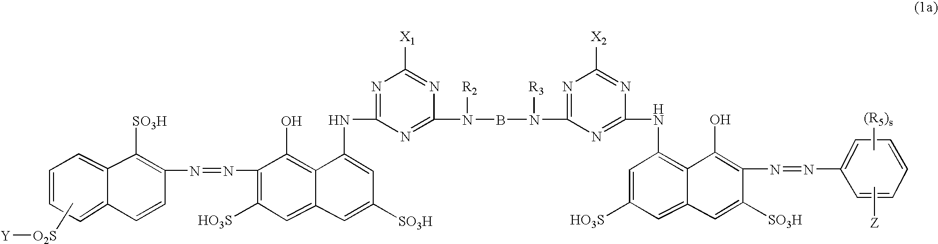
wherein
R₂ and R₃ are hydrogen,
(R₅)ₛ denotes s identical or different substituents selected from the group sulfo, methyl and methoxy,
B corresponds to a radical of formula —CH₂—CH(R₇)— or —(R₇)CH—CH₂— wherein R₇ is methyl,
X₁ and X₂ are chlorine,
s is an integer from 0 to 2, and
Z is a fibre-reactive group of formula
—SO₂—Y (2a)
wherein Y is vinyl or β-sulfatoethyl.

8. A process for the preparation of a reactive dye of formula (1) according to claim 1, wherein approximately 1 molar equivalent of each of the compounds of formulae 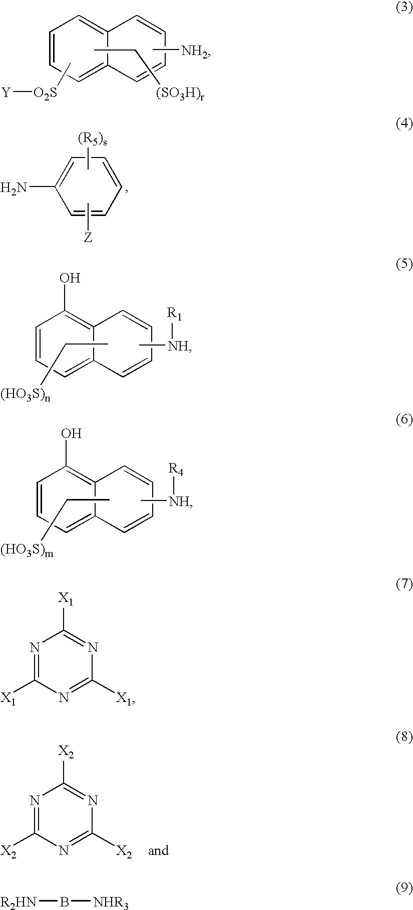
are reacted with one another in a suitable order, R₁, R₂, R₃, R₄, R₅, B, X₁, X₂, Y, Z, n, m, r and s in each case being as defined in claim 1.

9. A method of dyeing or printing of hydroxyl-group-containing or nitrogen-containing fibre materials, which comprises contacting said materials with a tinctorially effective amount of a reactive dye of formula (1) according to claim 1.

10. A method according to claim 9, wherein cellulosic fibre materials are dyed or printed.

11. An aqueous ink comprising a reactive dye of formula (1) according to claim 1.

12. A method of printing textile fibre materials, paper or plastics films by the inkjet printing method, which comprises contacting said materials with an aqueous ink according to claim 11.

13. A method according to claim 9, wherein cotton-containing fibre materials are dyed or printed.
